(19) United States
(12) Patent Application Publication
(10) Pub. No.: US 2003/0005233 A1
(43) Pub. Date: Jan. 2, 2003

(54) Dual organization of cache contents

(75) Inventors: J. Peter Stewart, Boca Raton, FL (US); Glreesh Sadasivan, Coral Springs, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: Daleen Technologies, Inc., Boca Raton, FL

(21) Appl. No.: 09/894,602

(22) Filed: Jun. 28, 2001

(51) Int. Cl. G06F 13/00

(52) U.S. Cl. 711/136

(57) ABSTRACT

A method, and computer readable medium for control of data in a caching application. An indexed list of a type is used to hold cache elements for ease of lookup while a linked usage list is maintained for the Most Recently Used/Least Recently Used elements. Pointers between the lists are also maintained. This allows the cache to find both a specific entry if it exists and if it does not, and in the latter case the LRU element can be located without the need for a sequential search. Each element in the linked list holds a pointer to a cache element in the, and each cache element record in the indexed list also holds a pointer to its corresponding record in the linked list, in addition to the actual cached data.

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### CROSS REFERENCE TO RELATED APPLICATIONS

Not Applicable

### BACKGROUND OF THE INVENTION

1. Field of the Invention

This invention generally relates to the field of computer memory management, and more particularly to computer caching methods and systems, especially as applied to large data files and databases.

2. Description of the Related Art

Caching data from slower storage to faster storage is well known. The storage may be faster or slower due to a variety of factors including storage technology. There are many factors, which directly affect the speed of storage. These factors include storage technology e.g., solid state RAM (Random Access Memory) vs. mechanical hard-drives, combined with relative distance and communication throughput between the storage source and the requested destination. Computers use caching methods to enable faster data access the second or subsequent time that accessed data is retrieved. In addition, related data retrieved from memory is also available very quickly. An example of related data access is occurs when accessing a web page on the Internet. Many times only text is what is sought but the entire page from a web site is downloaded with both pictures and text. The initial information is received along with related information.

Well-known cache managing techniques enable the location of data elements in a cache quickly. One solution is to organize cache elements in an indexed list of some type. This cache technique although useful does have its shortcomings. One shortcoming is the inability to determine which element is the least-recently-used (LRU) element. Scanning the whole list, to compare time stamps, takes a significant amount of time. Determining the LRU is especially important where the cache is providing only a subset of some larger data set such as a database table. Accordingly, a need exists to provide access to data based on context of the data while being able to also determine what data must be discarded.

Exemplary Computer System

Referring to FIG. 1, there is shown a block diagram 100 of the major electronic components of an information processing system 100 in accordance with the invention. The electronic components include: a central processing unit (CPU) 102, an Input/Output (I/O) Controller 104, a mouse 132 a keyboard 116, a system power and clock source 106; display driver 108; RAM 110, ROM 112, ASIC (application specific integrated circuit) 114 and a hard disk drive 118. These are representative components of a computer. The general operation of a computer comprising these elements is well understood. Network interface 120 provides connection to a computer network such as Ethernet over TCP/IP or other popular protocol network interfaces. Optional components for interfacing to external peripherals include: a Small Computer Systems Interface (SCSI) port 122 for attaching peripherals; a PCMCIA slot 124; and serial port 126. An optional diskette drive 128 is shown for loading or saving code to removable diskettes 130. The system 100 may be implemented by combination of hardware and software. Moreover, the functionality required for using the invention may be embodied in computer-readable media (such as 3.5 inch diskette 130) to be used in programming an information-processing apparatus (e.g., a personal computer) to perform in accordance with the invention.

Given this computer system, the performance is based in part on having the often-used data available to the processor. This is accomplished by moving the actively used data from the hard-drive or I/O ports to the RAM, and even to the Microprocessor platform. Accordingly the need exists for new and improved methods for control and movement of this often used data.

Example Software Hierarchy

FIG. 2 is a block diagram 200, illustrating the software hierarchy for the information processing system 100 of FIG. 1 according to the present invention. The BIOS (Basic Input Output System) 202 is a set of low level of computer hardware instructions for communications between an operating system 206, device driver 204 and hardware 200. Device drivers 204 are hardware specific code used to communicate between an operating system 206 and hardware peripherals such as a CD ROM drive or printer. Applications 208 are software application programs written in C/C++, assembler or other programming languages. Operating system 206 is the master program that loads after BIOS 202 initializes, that controls and runs the hardware 200. Examples of operating systems include Windows 3.1/95/98/ME/2000/NT, Unix, Macintosh, OS/2, Sun Solaris and equivalents. One application running on the operating system 204 is a relational database product such as the Oracle Database server, IBM DB/2, Microsoft SQL Server or equivalent.

The information processing system 200 can be configured as a server coupled to one or more clients through a network. (Not shown.) The network can be a private Intranet, Internet or other computer network. In the preferred embodiment, the protocol is HTTP (Hyper Text Transfer Protocol) and the exact hardware/software protocol is not important to this present invention and should not be limited. The clients are capable of running Microsoft Windows 3.1/95/98/NT/2000 or equivalent operating systems.

Given this software hierarchy the need exists for additional software that will allow for the just described applications to run in an efficient way by using caching methods that will obviate long and repetitive searching for data and applications.

Memory Hierarchy

FIG. 3 illustrates a block diagram 300 of four levels of a computer memory. The description to follow is exemplary in nature, and is generally how personal computer memories are designed. The L1 memory 302 is contained on the same chip as the Microprocessor such as an INTEL™ Pentium™ III. The memory operates at the same clock speed as the processor and can be accessed with no latency. The density is about 32 k bytes. This is where the often-used data and instructions are placed. In an example, if a book were being read the L1 would contain not only the first sentence that was requested but also the entire page. This concept is known as drag along.

The L2 memory 304, is typically on the same package that contains the microprocessor. It operates with no latency and at the same external clock speed. The density is about 512K bytes and contains more of the information then was stored on the L1. Using the book example the L2 would contain several pages of the chapter.

The L3 memory 306, is typically on the same mother board and is usually DRAM. (Dynamic Random Access Memory) There are several wait states for accessing this memory and the clock speed is a fraction of the microprocessor speed. The density is currently about 64-256 Mbytes. In the example of the book this memory may contain the balance of the chapter of the book.

The L4 memory 308, is typically a hard drive. It operates mechanically and therefore the access is quite slow. When data is requested the storage platter must be spun into position and the magnetic read arm must be indexed to the correct track. Finally a sector of data must be read.

In general the L1 cache is fast, local, shallow and expensive. At the other extreme is the L4 hard drive, which is slow, distant, dense and inexpensive.

Proper cache management dictates that the each cache level should be kept as up to date as possible with the recently requested data. If proper cache management techniques are not used, performance can suffer due to such problems as making frequent data calls from higher lever memory. One undesirable example of this is known as cache thrashing. Thrashing occurs when the cache loads data then stores back this data back to the hard drive only to recall it shortly afterwards. Accordingly the need exists for the communication and control of data between the different cache layers, so that this data can be usually available to the microprocessor by having the often-used data and instructions as close as possible.

Dictionary to Encyclopedia Hierarchy

Turning now to FIG. 4, illustrated is a block diagram 400 of a local fast dictionary of recently requested animals (by example). Each entry 404-410 contains some information that has been requested (and optionally a pointer back to the full database or encyclopedia 412 of information about the animals 414-440).

Dogs 410 in the dictionary may contain descriptions about their life span, as they are being compared to cats 408, birds 406 and aardvarks 404. However, if more information is required about these previously selected animals the dictionary may also contain the location in the encyclopedia, which enables faster recall of requested information such as full-grown size. Note that there are two possible relations between the material in the cache (the dictionary of the example) and the larger set of data (the encyclopedia of the example): 1) the cache may hold the complete information of each cached encyclopedia entry, or 2) the cache may just hold the most frequently used parts of each entry, as described above. In both cases, however, the larger data set (the complete “encyclopedia”) may be too large to fit in cache memory, i.e. the encyclopedia may contain information about 10,000 animals but the dictionary only has room for 500.

In order for large databases of information to be useful, they must be sorted according to certain attributes. For our example, each dictionary entry would be added to a search index as it is inserted into the dictionary. The search index (alphabetic in this case) allows for very efficient searching of the dictionary, to find out if it contains a specific entry. The database can be viewed as a full and complete encyclopedia, whereas the alphabetically indexed list can be viewed as an abbreviated dictionary and possibly also a local reference back to the encyclopedia.

Working with the dictionary in this way allows for very fast and efficient data access and processing of previously requested information. However once the dictionary is full, a decision must be made as where to put the newly requested data, say a request for information about eagles. Normal caching techniques dictate that the LRU (Least-Recently-Used) entry should be cast off and the new information should be stored. One method to keep track of this would be to add a timestamp, marking the time of the last access, to each entry in the dictionary. However in order to determine which entry is the LRU, every single time stamp must be scanned, which takes time. Accordingly the need exists for a more efficient method to quickly determine which entry in the dictionary is the LRU, while maintaining the indexed dictionary structure.

Flow Diagram of Prior Art Caching Methods

Turning now to FIG. 5 flow diagram 500 shows the prior art for the determination of the LRU. The flow diagram 500 is entered at 502 when a request for EAGLES information is made 504. If the EAGLES information is in the cache 506, then the time stamp is updated 524 which causes EAGLES to be identified as the MRU, then the information is used 526. If it is not in the cache 506, the information is pulled 508 from the next higher level of memory. Once the EAGLES information has been retrieved, the EAGLES information is stored 512 in the cache if there is space 510, the time stamp is updated 524, and then the information is used 526. If there is no space 510, then a sequential search of all of the time stamps in the cache is made 514, which determines the LRU. This search must be of the complete contents of the L1 so as to compare the time stamps of all of the entries. The time required for this search can be quite long and will directly impact the response time of the request for the EAGLES information. Once the search is completed, the LRU has been located 516, and the LRU tag is passed to the next Least Recently Used entry. The EAGLES information can now be stored 520 in the cache and the time stamp reflects the fact that it is now the MRU, and the search index is updated 522. The time stamp for the EAGLES is updated 524. Finally, the newly stored EAGLES information can be used 526 and the flow diagram 500 is exited, 528.

The sequential search of all of the time stamps required to find the LRU each time a new entry is required in the cache is very time consuming. Accordingly there exists the need for a more efficient method for determining which dictionary entry is the LRU.

### SUMMARY OF THE INVENTION

Briefly, according to the present invention, disclosed is a method, a system and computer readable medium for simultaneous locating within a cache memory a particular element of information based on a dual indexing scheme consisting of an search index and a second index in the form of a linked list to track usage.

The search index is used to quickly locate elements in the cache. The cached elements are organized in an indexed list that permits fast lookup based on the organization of the index. The search index could be organized using any of a number of standard schemes, such as a hash table, a B+Tree index, or any other method that allows quick lookups using a key value.

The usage-linked list is used to maintain the chronological order of the elements, by always re-linking to put the most-recently-used (MRU) item first in the linked usage list. This procedure automatically ensures that the least-recently-used element (LRU) is always last in the usage-linked list. By combining the two lists, the indexed dictionary list and the usage-linked list, not only can a data element be located very quickly via the ordering of the index, but also locating the MRU, and LRU element in the usage-linked list is possible. This allows for fast cast off of the LRU data and thus provides for the storage for new data.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a block diagram of an exemplary computer system that includes optional components, upon which the present invention can be implemented.

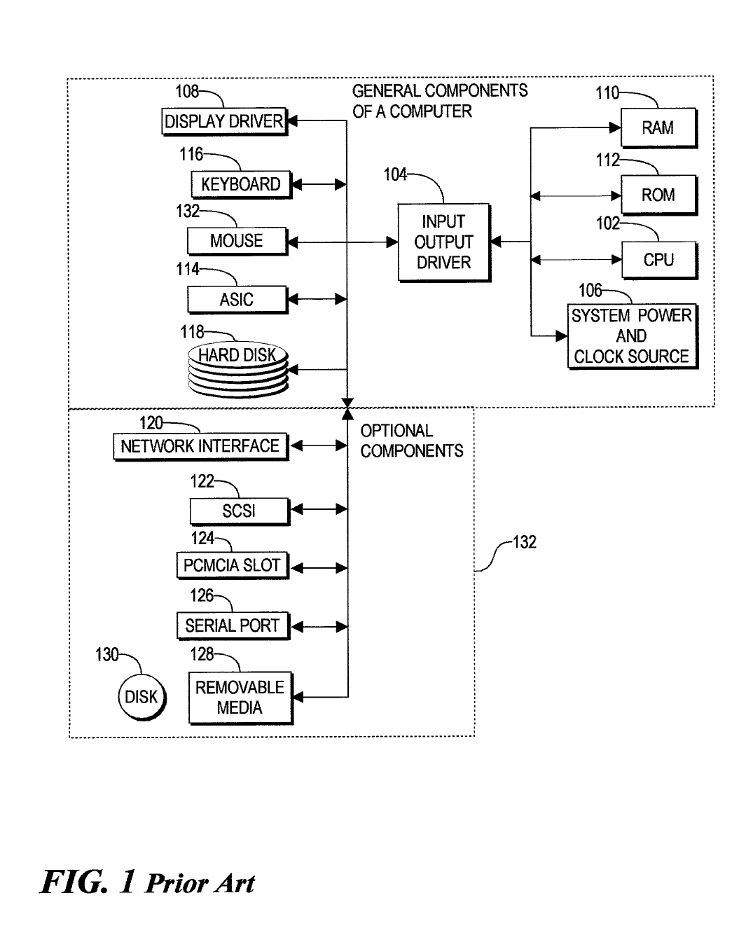

FIG. 2 is a block diagram of an exemplary software hierarchy that executed on the hardware of FIG. 1

FIG. 3 is a block diagram of a memory hierarchy that is currently used in commercially available microprocessor systems.

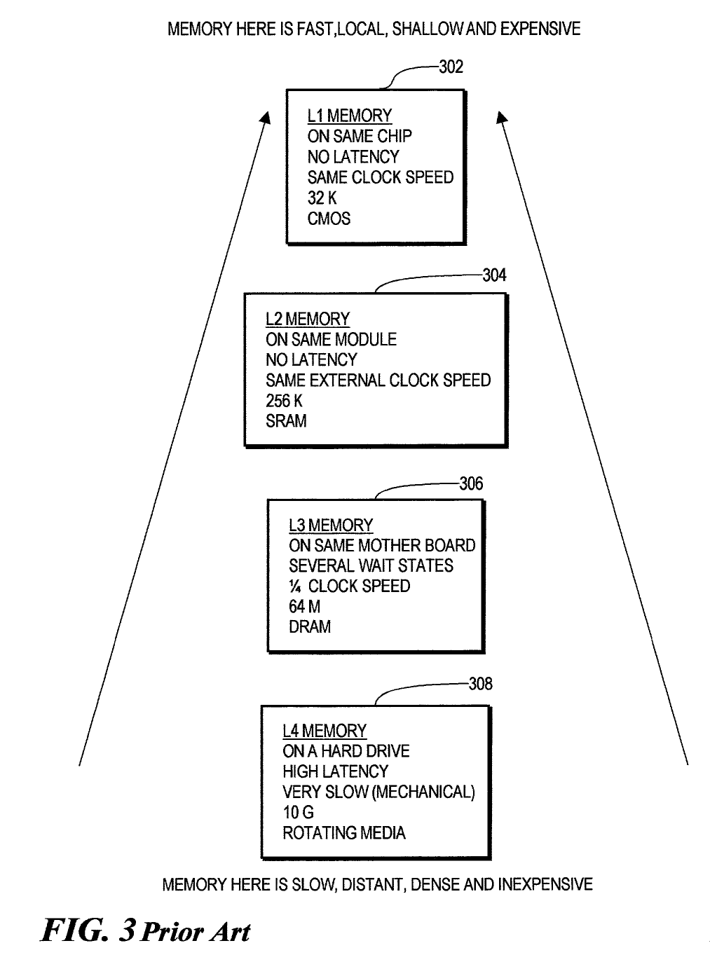

FIG. 4 is a block diagram of a dictionary to encyclopedia hierarchy, as used in the prior art.

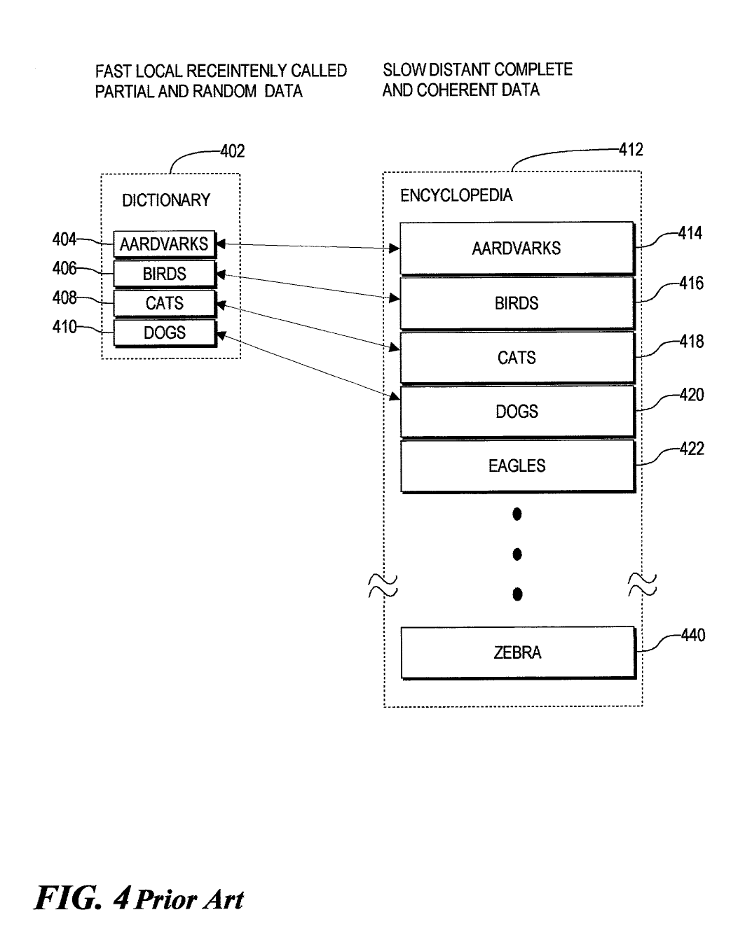

FIG. 5 is a flow diagram of prior art caching accessing methods.

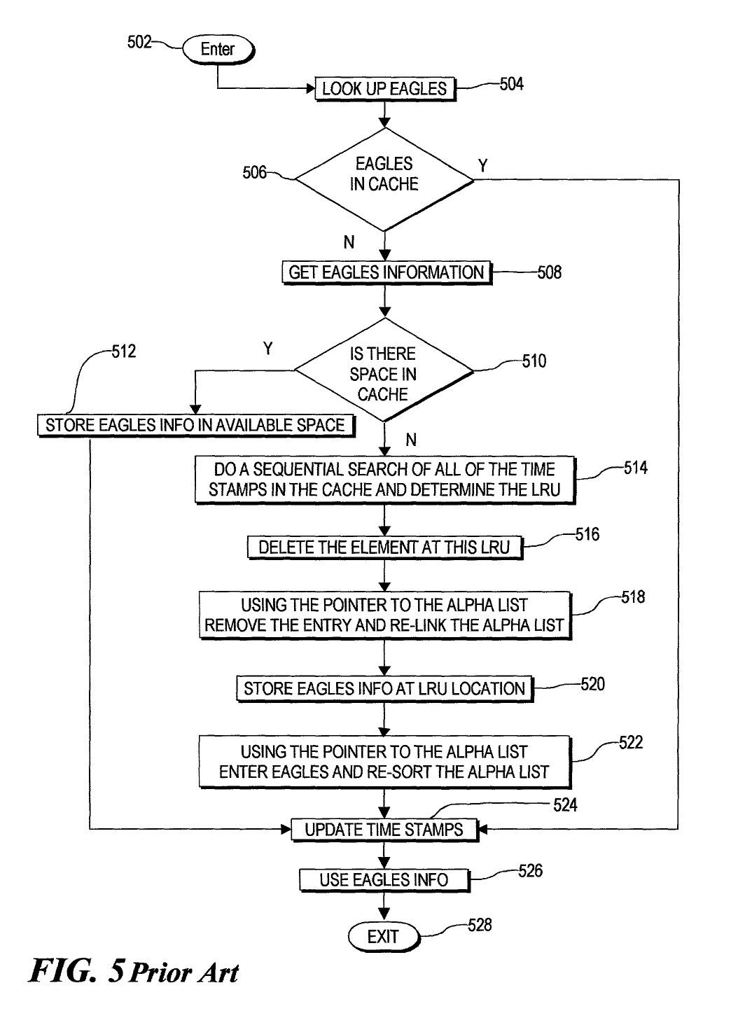

FIG. 6 is a block diagram of a dual indexing topology, according to the present invention.

FIG. 7 is a block diagram of a demonstration of dual indexing using a search index and a linked list for tracking usage, according to the present invention.

FIG. 8 is a flow diagram of dual indexing being used to access a cache, according to the present invention.

### DETAILED DESCRIPTION OF AN EMBODIMENT

It is important to note, that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

In the drawing like numerals refer to like parts through several views.

Discussion of Hardware and Software Implementation Options

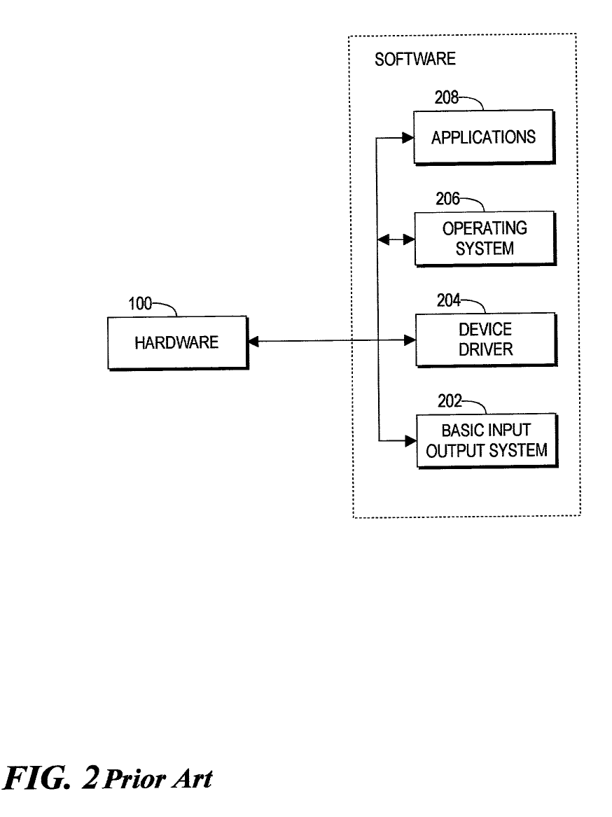

The present invention as would be known to one of ordinary skill in the art could be produced in hardware or software, or in a combination of hardware and software. However in one embodiment the invention is implemented in software, particularly an application 206 of FIG. 2. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

Dual Indexing Topology

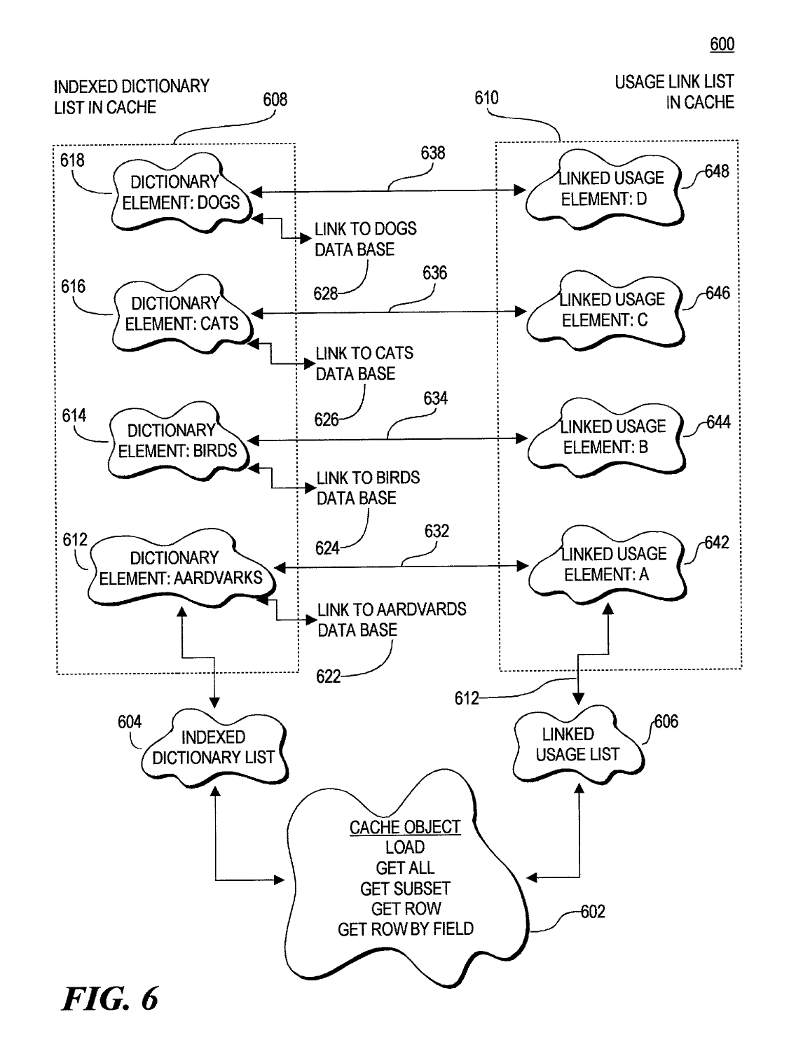

FIG. 6 is a block diagram 600 of a dual indexing topology, according to the present invention. Shown is a cache object 602 containing two hierarchies: (i) an indexed dictionary 604; and (ii) a linked usage list 606. This cache object 602 locates files based on an alphabetical look up of the indexed dictionary 604. In this embodiment, the indexed dictionary 604 is shown as an alphabetically indexed dictionary list 604. But other types of search indexes are contemplated and they are within the true scope and spirit of the present invention. The indexed dictionary in this example contains animals, with the index sorted alphabetically 604. Alternatively numeric sorting is complemented or some combination of both.

Independent of the method used to order the indexed dictionary 604 is the method of searching the indexed dictionary list. Techniques such as an attached sequence number or a hash key may be used and are really independent of the order of the indexed dictionary list. In the example below the order is alphabetical starting with AARDVARKS. Using such a list of animal names a search for a particular animal requires a lookup using alphabetical names of at lease 9 characters each (the size of AARDVARKS) across 1000 entries. Whereas, if a simple index number is associated with each entry, the lookup is accomplished by comparing only three numbers 999. With this search index, the present invention performs a very fast lookup on the indexed dictionary list.

A usage-linked list 606 contains two entries the MRU and the LRU based on the usage of the elements from a most-recently-used (MRU) element through a least-recently-used (LRU) element. The indexed dictionary 604 contains the locations of the dictionary elements in the cache 608. The indexed dictionary list 604 contains: AARDVARKS 612, BIRDS 614, CATS 616 and DOGS 618. A search is performed for a particular element in the cache 608. It is important to note that using known indexed searching techniques that the entire set of elements in the cache 608 does not need to be searched. Stated differently, using known indexed searching techniques, a search for EAGLES might only look at elements in the cache 608 located alphabetically between “D” and “F” in the dictionary 604. Each element 612-618 in the dictionary index 604 contains its specific address in the cache. Each element 612-618 in the dictionary 604 also contains a link to an entry in the usage-linked list 606, as further explained below. If information on an animal is requested, the dictionary index 604 is accessed to determine if the requested animal is in the cache 608. If the accessed animal is in the dictionary 604, the dictionary index 604 contains its particular location in the cache 608.

Continuing further, the alphabetically indexed dictionary 604, contains the (optional) links back to the database are listed as 622 for AARDVARDS, 624 for BIRDS, 626 for CATS and 628 for DOGS. Finally, each dictionary element 612-618 contains a cross-link to a corresponding entry in the usage-linked list 606 in cache 610. In the indexed dictionary 604 the cross-links are listed as: 632 for the AARDVARKS to linked list element: A, 634 for the BIRDS to linked list element: B, 636 for the CATS to linked list element: C, and finally 638 for the DOGS to linked list element: D.

If the requested animal is not in the dictionary index 604, the usage-linked list 606 is accessed to determine which entry in the cache is the LRU. The usage-linked list 606 contains the address location of the two entries, which are the MRU, and the LRU elements based on the historic usage. These entries are updated 612 each time the dictionary is accessed.

It is important to note, that this structure of cross referenced dual indexes enables a look up and fast access of information that is in the cache, 608, 610. This dual indexing scheme also allows for fast access of additional information that is in the database but not yet in the cache 608, 610. If the information is not in the cache the linked usage list is used to determine the LRU's address location in cache 608, 610. The requested information is now stored in this LRU location. The maintenance of the cross pointers and indexed dictionary 604 and linked usage list 606 takes less time than full sequential searches for the location of the sought for data if it is in the cache 608, 610.

In another embodiment, or as an optional feature for improved accessing to a database a pointer or pointers is included. For this embodiment, each of the linked dictionary elements 612-618 includes pointers 622-628 back to the source of the information in the memory or storage such as a database. The use of these pointers 622-628 enables the indexed dictionary list 604 to retrieve additional information as necessary. The additional information retrieval is especially important for a smaller indexed dictionary list, which, because of its size cannot hold all the relevant information. Returning to the example of animals, if additional information is required from the database searching for the location of the additional information is not required. This is because each animal's entry 612-618 in the cache contains links 622-628. The links greatly increase the speed of lookup.

In still, another embodiment, both the number of items in the indexed dictionary 604 along with the size of each item is known prior to the loading of the cache. With the number of items and the size of each item known, the exact size of the cache is known. It is also important to note that once an item in the double-linked list for usage tracking has been allocated, it never needs to be de-allocated or moved in memory in any way—all updates to the ordering of elements is done by changing pointers to reference new elements. Accordingly, the double linked list for tracking usage can be allocated as a single memory block, with all the list items adjacent to each other in memory. In essence, this would be an array of linked list elements. The elements could be addressed just like items in a traditional double-linked list, by pointers to each memory location. However, they could just as easily be addressed by their position in the array of elements, just by replacing the memory pointer by their index. Stated differently, the calculation for the maintenance of the pointers is more efficient using relative addressing comprising a base address, which is the start of the memory block and an offset to the particular entry. Moreover, the allocation of a predetermined or known cache size permits very fast initial loading of the double linked list for tracking usage and may alleviate memory fragmentation and some of the overhead imposed by memory managers.

Yet another embodiment would be to merge the double-linked list with the alphabetic index, so that each item in the alphabetic index would contain the embedded previous and next pointers of a double-linked list. These index entries could be maintained in exactly the same manner as a traditional separate linked list.

Demonstration of Dual Indexing

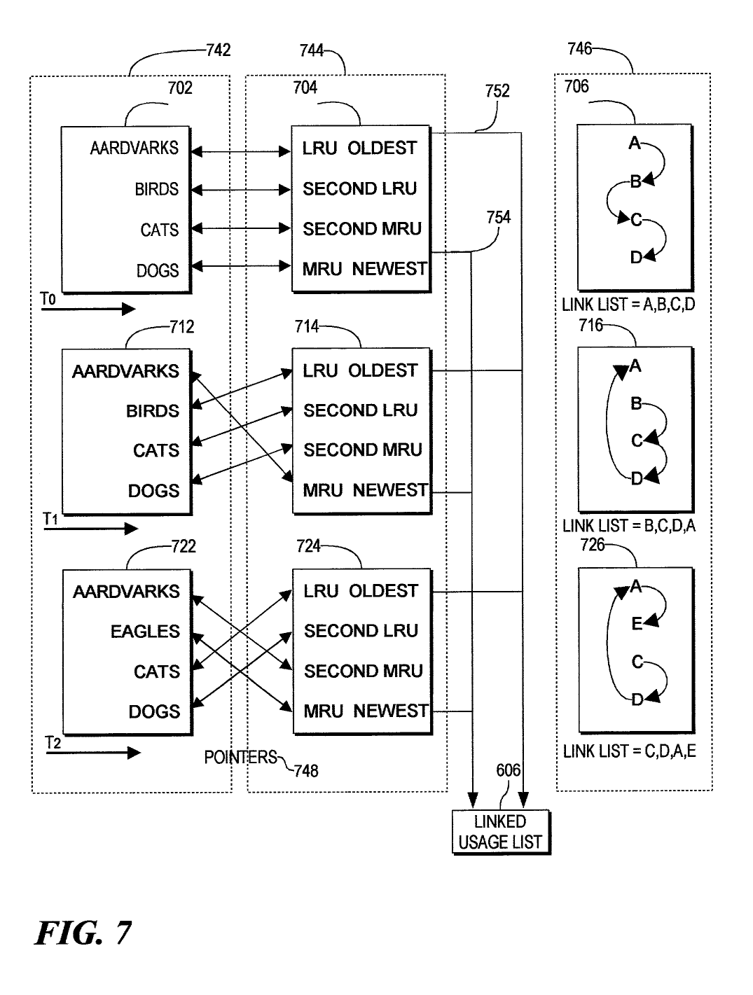

Turning now to FIG. 7, which contains block diagram 700 of the demonstration of the dual indexing using the linked dictionary list 604 and the linked usage list 606, according to the present invention. Illustrated are three separate times states t₀, t₁, and t₂, During the four steps or states in time, the state of the dictionary 742, the linked usage list 744 and the linked list vector 746, with the resultant entry in the linked usage list 606 are now described. At time t₀, the dictionary 702 contains the simple list of AARDVARKS, BIRDS, CATS and DOGS. Each of these entries is pointing 748 to a unique entry in the double-linked list for tracking usage 704. The AARDVARKS entry is pointing to the LRU as it was loaded first. Next entries are BIRDS, CATS and finally DOGS, which is the MRU. The resultant linked list vector 706 is as simple as A to B to C to D. The linked usage list 606 contains A, which is the LRU and D, which is the MRU. Whenever an item becomes the LRU or the MRU, a pointer identifying this item must be updated.

At time t₁, the entry AARDVARKS is accessed. The data location in the dictionary is not changed 712. However, the usage-linked list 714 is adjusted. AARDVARKS is now the MRU and the other entries are re-linked so that BIRDS is the LRU. The linked list vector is 716 is now B to C to D to A. Therefore the linked usage list 606 contains B which is the LRU and A, which is the MRU. Note that nothing is ever-moved in memory, the only thing that changes is how pointers link the items in the list. This eliminates any overhead involved in memory management and memory fragmentation. Therefore no time is wasted moving data around in memory, only the usage linked list is updated.

At time t₂, a request is made for EAGLES information. By accessing the indexed dictionary 604 in FIG. 6, it is quickly determined that the entry EAGLES is not in the cache 608. The location of the LRU to be used in this full cache is easy to determine by accessing the usage-linked list 606 in FIG. 6 and its LRU pointer. The address location of the LRU is currently pointing to the BIRDS entry. The entry BIRDS is removed from the indexed dictionary list and the entry EAGLES is added. The linked usage list 606 is updated to point to EAGLES and this node in the list is re-linked to become the MRU. The dictionary list 722 now contains AARDVARKS, CATS, DOGS and EAGLES 722. The usage-linked list 724 contains the resultant new list with EAGLES being the new MRU, and the other entries, AARDVARKS, CATS and DOGS. The linked list vector is C to D to A to E. The linked usage list 606 contains C, which is the LRU, and E, which is the MRU.

Flow Diagram of a Dual Indexing According to the Present Invention

It is noted that when accessing records in a database, which is typically stored on a hard disk, access time may become significant. This can be exacerbated when several database lookups are involved. Specifically, if the topmost list is stored on one hard drive sector and this list points to other hard drive sectors significant time is used in locating the sought for entry. In one embodiment of the present invention techniques such as B+trees are used to minimize this. This technique is preferred when decision points, called nodes, are on a hard disk rather than in random-access memory. B+trees save time by using nodes with many branches. This allows for fast location of a data item by passing through fewer nodes. Once located, the record is retrieved. Next, the pointers to the record are added to the indexed dictionary list 604 and to the linked usage list 606. Finally, the indexed dictionary list 604 and the linked usage list are updated. Alternatives to the B+trees technique are techniques that use hash codes, binary trees, numerical indexing, or any of numerous techniques for organizing alphabetical indexes.

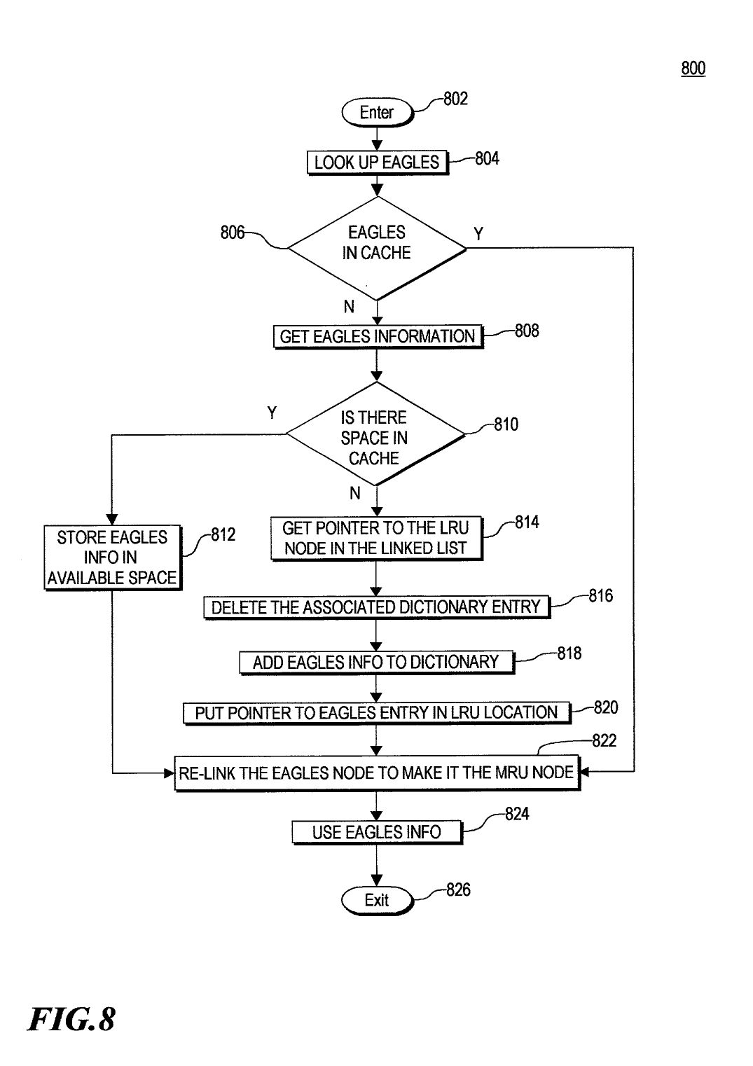

Turning now to FIG. 8, shown is a flow diagram 800 of a dual-indexed cache, according to the present invention. The flow diagram 800 is entered 802 with a request for EAGLES information 804. The dictionary index 604 of FIG. 6 is accessed to determine if EAGLES is in the cache. If the EAGLES information is in the dictionary index 604, the EAGLES element includes the address location in the cache 806. The EAGLES element in the usage-linked list is re-linked to make this item the MRU 822, and the EAGLES information is used 824.

If EAGLES is not found 806 in the dictionary index 604, then the information must be fetched 808 from the next higher memory level, such as a database. A check is performed to determine if there is space available in the cache 810. If there is, the EAGLES information is stored 812, the Eagles linked usage list is re-linked to make this file the MRU 822, and then used 824.

If there is no space 810 then according to the present invention, the LRU element from the usage-linked list 606 of FIG. 6 is accessed to determine the LRU element location 814. Now, the information in the LRU element location is deleted 816 if necessary. The EAGLES information can now be added to the cache 608, and the dictionary index 604. The usage-linked list now points to the desired EAGLES information. The usage-linked list is re-linked to change the LRU element to the MRU element 822, and the dictionary index 604 is updated. Finally, the flow diagram 800 is exited 826 by using the EAGLES information 824.

Glossary of Terms Used in this Disclosure

ALPHA LIST—is an indexed list that has been sorted with respect to the (usually) ascending alphabet. With an alpha list a search for an entry name based on the corresponding index order, which in the alpha list is the alphabetical position. It should be noted that if an alpha list search does not find the entry at the correct alphabetical location on the alpha list, then the entry is not in the alpha list.

B-Tree—is a method of placing and locating records in a database. The B-tree algorithm minimizes the number of times a medium must be accessed to locate a desired record, thereby speeding up the process.

B-trees are preferred when decision points, called nodes, are on hard disk rather than in random-access memory (RAM). It takes thousands of times longer to access a data element from hard disk as compared with accessing it from RAM, because a disk drive has mechanical parts, which read and write data far more slowly than purely electronic media. B-trees save time by using nodes with many branches (called children), compared with binary trees, in which each node has only two children. When there are many children per node, a record can be found by passing through fewer nodes than if there are two children per node.

B+-tree—is an improved version of the B-Tree algorithm that optimizes search times by ensuring that the tree is always balanced. A B-tree may easily become “unbalanced”, meaning that some branches (search paths) are much longer than others, for example if a lot of records were stored under the letter “S”. The B+-tree ensures a balanced tree by enforcing a max. height and splitting the nodes (pages) as needed to ensure that the max. height is never exceeded. To use the example where many records are stored under the letter “S”, page splitting would ensure that there were a number of top level pages for the letter “S” instead of a single one sitting on top of a tall tree.

CACHE—is a memory location to store information temporarily. One example of a cache used is where Web pages are stored on a browser's cache directory on a system's hard disk. If a user returns to a page previously visited, the browser may access the page from the cache rather than the original server, saving both time and the network the burden of some additional traffic. Another example of a cache used is a RAM disk cache that contains the data most recently read in from the hard disk. A cache can comprise many different memory technologies including volatile, non-volatile, electronic, mechanical, chemical and organic.

DATABASE—is a collection of data that is organized so that its contents can easily be accessed, managed, and updated. The most prevalent type of database is the relational database. A relational database is a tabular database in which data is defined so that it can be reorganized and accessed in a number of different ways. A distributed database is one that can be dispersed or replicated among different points in a network. An object-oriented programming database is one that is congruent with the data defined in object classes and subclasses.

DICTIONARY—is a collection of data objects or items in a data model that are indexed for rapid accessing. This indexing may use any of a number of standard schemes, such as a hash table, a B+Tree, or any other method that allows quick lookups using a key value. This collection can be organized for reference into a database.

DUAL INDEXING—is a scheme whereby two indexes are combined to simultaneously optimize two different types of lookups. Each index would contain the information that is normal for its type (alphabetic index or double-linked list), but in addition each entry also points to a corresponding entry in the other list. An example is an element in a dictionary index that contains a pointer to an entry in a double-linked list (a usage index) that contains the usage order of each item in the dictionary.

ENCYCLOPEDIA—is a source of information that is used to construct a collection of data objects. These data objects, taken together are also known as a DICTIONARY. The DICTIONARY, once constructed is used during caching to improve performance and to point to the specific location of additional data that resides in the ENCYCLOPEDIA.

HASHING—is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

As a simple example of the using of hashing in databases, a group of animals could be arranged in a database like this:

Aardvarks

Birds

Cats

Dogs

(and many more sorted into alphabetical order)

Each of these animals would be the key in the database for that animal's data. A database search mechanism would first have to start looking character-by-character across the name for matches until it found the match (or ruled the other entries out). But if each of the names were hashed, it might be possible (depending on the number of animals in the database) to generate a unique four-digit key for each name. For example:

7864 Aardvarks

9802 Birds

1990 Cats

8822 Dogs

(and so forth)

A search for any name would first consist of computing the hash value (using the same hash function used to store the item) and then comparing for a match using that value. It would, in general, be much faster to find a match across four digits, each having only 10 possibilities, than across an unpredictable value length where each character had 26 possibilities.

INFORMATION—is any data and code that is used by a computer including text, graphics, audio, video and multimedia content.

LINKED LIST—is list, sometimes called a chained list in which the elements of the list may be dispersed but in which each element contains information, typically a pointer, for locating the next element in the list. Two examples of linked lists are a single-linked list, where each element (in addition to the data it holds) only has a pointer to the next element, and a double-linked list, where each element also has a pointer to the previous element. In applications where the ordering of the elements often has to be changed, it is more efficient to use a double-linked list since a single-linked list forces you to scan from the beginning of the list every time you need to find the previous element to re-link the chain.

Non-limiting Examples

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

Link

What is claimed is:

1. A method for organizing information into a cache memory subsystem, the subsystem containing a database of information elements stored in memory, and a subset of the database of information elements stored in a cache memory, the method comprising the steps of:
forming an indexed list for holding information elements in a predetermined order based on the indexing method being used;
forming a linked usage list based on the historic use of information elements including a most-recently-used (MRU) information element and a least-recently-used (LRU) element so that the indexed list and the linked usage list together form a dual indexing scheme for the information elements;
receiving a request for an information element;
determining if the requested information element is not in cache by searching the indexed list, and if the requested information element is not in cache, then determining if there is cache memory space available and if there is no cache memory space available then performing the sub-steps of:
determining a location of the LRU information element from the linked usage list;
updating the pointer to the LRU informational element in the indexed list;
updating the LRU informational element entry in the linked usage list;
updating the information element requested from a information source; and
storing the requested information in the cache.

2. The method according to claim 1, further comprising the sub-steps of:
updating the indexed list based on an index order; and
updating the linked usage list based on the historic use of the information elements.

3. The method according to claim 1, further comprising the sub-step of:
updating the linked usage list based on the usage order, and;
providing the new MRU and LRU entries.

4. The method according to claim 2, wherein the step of updating the indexed list based on an index order includes updating the indexed list based upon an alphabetical order or a numerical order or some combination of both an alphabetical and numeric order.

5. The method according to claim 2, further comprising the sub-steps of:
updating the linked usage list so that the location in the cache memory subsystem of the requested information element is now identified as the MRU location.

6. A method for management of a memory cache system comprising a plurality of information elements, comprising the steps of:
placing a plurality of information elements in an indexed list to enable searching of the information elements based on a position in the indexed list;
creating a linked usage list with a usage history from a most-recently-used (MRU) to a least-recently-used (LRU) based upon a set of information elements in the indexed list, wherein each member of the linked usage list contains a pointer back to a member in the indexed list so that the order of usage of the individual members of the indexed list is searchable by searching the linked usage list; and
receiving a request for an information element that is not in the indexed list, whereby an information element representing the requested information is placed in the indexed list replacing the least recently used information element as determined by the LRU element in the linked usage list.

7. The method according to claim 6, wherein the step of placing information elements includes placing pointers or keys into a database holding additional information elements.

8. The method according to claim 7, wherein the step of placing information elements includes placing pointers or keys into a database, further comprises the steps of:
associating each of the informational elements with a particular pointer, wherein the pointer is a number;
associating a location in the database holding additional information elements stored in memory with each of the informational elements, and;
associating each of the informational elements with a location in the indexed list.

9. The method according to claim 7, wherein the step of placing information elements uses a list of a predetermined and fixed size, allowing the linked usage list to be allocated as a single contiguous memory block and each element of the linked list to be accessed by its fixed position in the index, rather than by its physical memory address.

10. A method for addressing cached information in a memory cache sub-system, the method comprising the steps of:
loading one or more information elements using a list of a predetermined and fixed size, and allocating the linked usage list as a single contiguous memory block, allowing each element of the linked list to be accessed by its fixed position in the index, rather than by its physical memory address.
creating a linked usage list in cache with a usage history from a most-recently-used (MRU) to a least-recently-used (LRU) based upon a set of information elements in the indexed list, wherein each member of the linked usage list contains a pointer back to a member in the indexed list so that the order of usage of the individual members of the indexed list is searchable by searching the linked usage list; and
receiving a request for an information element that is not in the indexed list, whereby an information element representing the requested information is placed in the indexed list replacing the element identified by the LRU element in the linked usage list.

11. A computer readable medium containing programming instructions for organizing information into a cache memory subsystem, the subsystem containing a database of information elements stored in memory, and a subset of the database of information elements stored in a cache memory, the method comprising the steps of:
forming an indexed list for holding information elements in a predetermined order based on the indexing method being used;
forming a linked usage list based on the historic use of information elements including a most-recently-used (MRU) information element and a least-recently-used (LRU) element so that the indexed list and the linked usage list together form a dual indexing scheme for the information elements;
receiving a request for an information element;
determining if the requested information element is not in cache by searching the indexed list, and if the requested information element is not in cache, then determining if there is cache memory space available and if there is no cache memory space available then performing the sub-steps of:
determining a location of the LRU information element from the linked usage list;
updating the pointer to the LRU informational element in the indexed list;
updating the LRU informational element entry in the linked usage list;
updating the information element requested from a information source; and
storing the requested information in the cache.

12. The computer readable medium, according to claim 11, further comprising the sub-steps of:
updating the indexed list based on an index order, and;
updating the linked usage list based on the historic use of the information elements.

13. The computer readable medium according to claim 11, further comprising the sub-step of:
updating the linked usage list based on the usage order; and
providing the new MRU and LRU entries.

14. The computer readable medium according to claim 12, wherein the step of updating the indexed list based on an index order includes updating the indexed list consisting of an alphabetical order , or a numerical order or some combination of both an alphabetical order and a numerical order.

15. The computer readable medium according to claim 12, further comprising the sub-steps of:
updating the linked usage list so that the location in the cache memory subsystem of the requested information element is now identified as the MRU location.

16. A computer readable medium containing programming instructions for management of a memory cache system comprising a plurality of information elements, the programming instructions comprising:
placing a plurality of information elements in an indexed list to enable searching of the information elements based on a position in the indexed list;
creating a linked usage list with a usage history from a most-recently-used (MRU) to a least-recently-used (LRU) based upon a set of information elements in the indexed list, wherein each member of the linked usage list contains a pointer back to a member in the indexed list so that the order of usage of the individual members of the indexed list is searchable by searching the linked usage list; and
receiving a request for an information element that is not in the indexed list, whereby an information element representing the requested information is placed in the indexed list replacing an element determined by the LRU element in the linked usage list.

17. The computer readable medium according to claim 16, wherein the programming instruction of placing information elements includes placing pointers/keys into a database holding additional information elements.

18. The computer readable medium according to claim 17, wherein the programming instruction of placing information elements includes placing pointers or keys into a database, further comprises the steps of:
associating each of the informational elements with a particular pointer, wherein the pointer is a number;
associating a location in the database of information elements stored in memory with each of the informational elements, and;
associating each of the informational elements with a location in the indexed list.

19. The computer readable medium according to claim 17, wherein the programming instruction of placing information elements includes using a list of a predetermined and fixed size, and allocating the linked usage list as a single contiguous memory block, allowing each element of the linked list to be accessed by its fixed position in the index, rather than by its physical memory address.

20. A computer readable medium containing programming instructions for addressing cached information in a memory cache sub-system, the programming instructions comprising:
loading one or more information elements into an indexed list in cache memory using a list of a predetermined and fixed size, and allocating the linked usage list as a single contiguous memory block, allowing each element of the linked list to be accessed by its fixed position in the index, rather than by its physical memory address.
creating a linked usage list in cache with a usage history from a most-recently-used (MRU) to a least-recently-used (LRU) based upon a set of information elements in the indexed list, wherein each member of the linked usage list contains a pointer back to a member in the indexed list so that the order of usage of the individual members of the indexed list is searchable by searching the linked usage list; and
receiving a request for an information element that is not in the indexed list, whereby an information element representing the requested information is placed in the indexed replacing an element determined by the LRU element in the linked usage list.

21. A cache memory sub-system comprising:
a memory storage cache;
an indexed list formed in cache with a plurality of informational elements loaded in the indexed list whereby the information elements are searchable based on a position in the indexed list;
an linked usage list with a usage history from a most-recently-used (MRU) to a least-recently-used (LRU) based upon a set of information elements in the indexed list, wherein each member of the linked usage list contains a pointer back to a member in the indexed list so that the order of usage of the individual members of the indexed list is searchable by searching the linked usage list; and
means for receiving a request for an information element that is not in the indexed list, whereby a information element representing the requested information is placed in the indexed list replacing an element determined by the LRU element in the linked usage list.
